(19) United States
(12) Patent Application Publication
(10) Pub. No.: US 2009/0097526 A1
(43) Pub. Date: Apr. 16, 2009

(54) RELIABILITY TESTING OF SUB-MINIATURE INTERCONNECTS

(75) Inventors: Joseph J. Kreuzpaintner, Orlando, FL (US); Thomas Shenton, Indialantic, FL (US); Steven E. Wilson, Malabar, FL (US); Karen Wooldridge, Melbourne, FL (US); Lee Burberry, West Melbourne, FL (US); Hector Deju, Indialantic, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: HARRIS CORPORATION, Melbourne, FL (US)

(21) Appl. No.: 11/870,510

(22) Filed: Oct. 11, 2007

(51) Int. Cl. G01N 25/00

(52) U.S. Cl. 374/57

(57) ABSTRACT

The invention concerns a method and apparatus for performing an accelerated simulation of mechanical stresses and strains to evaluate the reliability of a sub-miniature interconnect. The method can begin by determining at least one characteristic of at least one thermal cycle to which a sub-miniature interconnect having a predetermined configuration will be exposed. The at least one characteristic can be selected to include a temperature change during the at least one thermal cycle. Thereafter, at least one value is calculated which represents a dimensional variation in a substrate (400) to which the sub-miniature interconnect is bonded. In particular, the dimensional variation is a calculated variation in the substrate dimension caused by the thermal cycle. The dimensional variation can include a longitudinal dimensional variation aligned with a length of the ribbon or the wire or a lateral dimensional variation aligned transverse to the ribbon or wire.

### STATEMENT REGARDING FEDERALLY SPONSORED RESEARCH OR DEVELOPMENT

This invention was made with government support. The government has certain rights in the invention.

### BACKGROUND OF THE INVENTION

1. Statement of the Technical Field

The inventive arrangements relate to methods and apparatus for determining the reliability and quality of interconnects used for microelectronic devices. More particularly, the present invention relates to a method and apparatus for providing an accelerated simulation of mechanical stresses induced in microelectronic interconnects which result from thermal variations occurring during the manufacture, test and use of equipment over a period of time.

2. Description of the Related Art

It is well known in the art that integrated or hybrid circuit chips can be mounted on a substrate. The integrated or hybrid circuit chips are electrically connected to conductive pads or adjacent circuit traces located on the substrate by using fine wires or ribbons formed from a conductive material. The fine wires or ribbons are typically attached to conductive pads or circuit traces utilizing a conventional thermo sonic bonding technique. In this regard, the conductive pads are also known as bonding sites. These electrical connections between the integrated or hybrid circuit chips and the substrate are commonly referred to as sub-miniature interconnects or micro-electronic interconnects.

Thermal cycling is one potential cause of failure for sub-miniature interconnects. Thermal cycling refers to thermal variations occurring during the manufacture, test and use of equipment over a period of time. It is known that such thermal cycling can induce mechanical stresses in microelectronic interconnects. The mechanical stresses applied to the interconnect arise mainly due to dimensional variations in the substrates that occur as a result of variations in temperature. More particularly, a sub-miniature interconnect can be connected at one end to a first substrate formed of a first material and at a second end to a second substrate formed of a second material. When subjected to temperature variations, the first substrate and the second substrate will expand or contract. The actual amount of expansion (or contraction) of each substrate will depend upon a coefficient of expansion associated with each material, the dimensions of the substrate, and the amount of variation in temperature.

Notably, variations in temperature will result in lateral and longitudinal dimensional variations of the first and second substrates. These lateral and longitudinal dimensional variations will result in the application of mechanical stresses to the sub-miniature interconnects. Over time, these mechanical stresses can cause an interconnect failure. Reliability qualification testing is employed in order to predict the reliability of a particular type of interconnect as between a first and second substrate.

One qualification test employed for determining the reliability of sub-miniature interconnects generally involves performing an accelerated thermal cycling utilizing a thermal chamber. The accelerated thermal cycling includes subjecting the sub-miniature interconnects, the integrated or hybrid circuit chips and the substrates to which they are attached to a number of temperature cycles. The temperature cycles include selectively varying a temperature of the interconnects and the substrates to which they are attached between a first pre-defined temperature and a second pre-defined temperature. As a result of the temperature cycling, the substrates experience thermal expansion and thermal contraction (i.e., negative thermal expansion). In effect, the sub-miniature interconnects are subjected to thermally induced strains and stresses. A more detailed description of accelerated thermal cycling can be found in “IPC-SM-785, Guidelines for Accelerated Reliability Testing of Surface Mount Technology, Institute for Interconnection and Packaging Electronic Circuits, Lincolnwood, Ill.” The entire disclosure of this publication is incorporated herein by reference.

It will be appreciated that electronics equipment incorporating sub-miniature interconnects can be subjected to a large number of temperature variations over the course of its operating lifetime. This is particularly true in the case of aerospace products which can routinely be subjected to widely varying temperatures on a frequent basis. Over the operating lifetime of such equipment, it may be subjected to thousands of such temperature variations. Simulating a lifetime of such temperature variations can be a very time consuming aspect of reliability testing.

In order to reduce the time required for such reliability testing, it is common practice to reduce the number of thermal cycles (i.e. temperature variations) and increase the extent of the temperature variations. Well known mathematical equations can be used to calculate the necessary extended temperature variations required for a reduced number of temperature cycles. Despite the advantages of this method of qualification testing, it suffers from certain drawbacks. For example, the stresses and strains produced by the extended temperature excursions can far exceed the actual stresses and strains experienced by a device in a mission environment. This over stress and strain condition can distort reliability predictions derived from the qualification test.

Further, although the accelerated thermal testing procedures can reduce the time required for such qualification testing, they can still require a relatively long period of time to complete. In this regard, it should be understood that the test procedure often requires weeks or months to complete. In view of the forgoing, there is a need for a test procedure capable of rapidly testing the reliability and quality of sub-miniature interconnects.

### SUMMARY OF THE INVENTION

The invention concerns a method and apparatus for performing an accelerated simulation of mechanical stresses and strains to evaluate the reliability of a sub-miniature interconnect, without exposing the interconnect to stresses and strains which exceed those induced during manufacture, functional testing, and use of equipment over its operational lifetime. The method can begin by determining at least one characteristic of at least one thermal cycle to which a sub-miniature interconnect having a predetermined configuration will be exposed. The at least one characteristic can be selected to include a temperature change during the at least one thermal cycle. Thereafter, at least one value is calculated which represents a dimensional variation in a substrate to which the sub-miniature interconnect is bonded. In particular, the dimensional variation is a calculated variation in the substrate dimension caused by the thermal cycle. The dimensional variation can include a longitudinal dimensional variation aligned with a length of the ribbon or the wire or a lateral dimensional variation aligned transverse to the ribbon or wire.

The method also includes testing a response of the sub-miniature interconnect to at least one thermal cycle. The testing process includes selectively varying a position of at least one bonding site where a ribbon or wire forming the sub-miniature interconnect is bonded to a substrate. Significantly, this step is performed exclusive of varying a temperature of the substrate or substrates to which the ribbon or wire is bonded. Instead, the position of the bonding site can be varied by using an actuator responsive to a computer control. According to one aspect of the invention, the actuator can be a piezoelectric actuator.

According to another aspect of the invention, the method further includes determining a first value representing a number of times it is anticipated that the sub-miniature interconnect having the predetermined configuration will be exposed to the thermal cycle. The testing step can be repeated a predetermined number of times based on the first value.

According to yet another aspect of the invention, the method includes assembling a sample of the sub-miniature interconnect having the predetermined configuration. The sample sub-miniature interconnect is formed by: temporarily securing a first substrate to a second substrate; bonding a conductive wire or ribbon to a first substrate at one end and to a second substrate at an opposing end; and unsecuring the first substrate from the second substrate after positioning the first substrate and the second substrate in a test fixture.

The method also includes moving the first substrate relative to a position of the second substrate to simulate a dimensional variation caused by the thermal cycle. The method further includes selecting the moving step to include moving the first substrate laterally relative to the second substrate to simulate the dimensional variation caused by the thermal cycle. Alternatively, the method includes selecting the moving step to include moving the first substrate longitudinally relative to the second substrate to simulate the dimensional variation caused by the thermal cycle.

The invention also includes an accelerated test method for sub-miniature interconnects. The method begins by determining a temperature variation to which a sub-miniature interconnect will be exposed. Thereafter, a determination is made as to a change in position that will occur as a result of the temperature variation as between a first bonding site to which the sub-miniature interconnect is connected on a first substrate, and a second bonding site to which the sub-miniature interconnect is connected on a second substrate. This determining step can be performed by calculation. Thereafter, the method includes simulating a mechanical response of the sub-miniature interconnect to the temperature variation by using an actuator to selectively vary a relative position of the first substrate with respect to the second substrate in accordance with the calculated change in position. The method advantageously includes performing the simulating step exclusive of any delay associated with establishing the temperature variation.

According to one aspect, the temperature variation can be selected to correspond to a predetermined thermal cycle over which a reliability of the sub-miniature interconnect is to be evaluated. In that case, the method can include repeating the simulating step a predetermined number of times corresponding to a number of the predetermined thermal cycles over which the reliability is to be evaluated. Significantly, the simulating step can be repeated the predetermined number of times exclusive of any delay associated with establishing the temperature variation.

The calculation used for determining the change in position of the first bonding site and the second bonding site can include calculating a change in a lateral position of the first bonding site relative to the second bonding site, wherein the change in lateral position is a positional change in a lateral direction defined transverse to an axis aligned with the first bonding site and the second bonding site. The calculation used for determining the change in position of the first bonding site and the second bonding site can also include calculating a change in a longitudinal position of the first bonding site relative to the second bonding site, wherein the change in lateral position is a positional change in a longitudinal direction defined by an axis aligned with the first bonding site and the second bonding site.

The simulating step described above can similarly involve using a first actuator to selectively vary a relative position of the first substrate with respect to the second substrate in a lateral direction in accordance with a calculated lateral change in position. Further, the simulating step can include using a second actuator to selectively vary a relative position of the first substrate with respect to the second substrate in a longitudinal direction in accordance with a calculated longitudinal change in position.

### BRIEF DESCRIPTION OF THE DRAWINGS

Embodiments will be described with reference to the following drawing figures, in which like numerals represent like items throughout the figures, and in which:

FIG. 1 is a block diagram of a tester that is useful for understanding the invention.

FIG. 2A is a schematic illustration of a longitudinal deflection test fixture that is useful for understanding the invention.

FIG. 2B is a schematic illustration of a lateral deflection test fixture that is useful for understanding the invention.

FIG. 3 is a flow diagram of a method for testing the reliability of sub-miniature interconnects that is useful for understanding the invention.

FIG. 4 is a perspective view of a substrate that is useful for understanding the invention.

FIG. 5 is a perspective view of a first substrate coupled to a second substrate that is useful for understanding the invention.

FIG. 6 is a perspective view of substrates having sub-miniature interconnects coupled thereto that is useful for understanding the invention.

FIG. 7 is a perspective view of substrates removably coupled to the longitudinal deflection test fixture shown in FIG. 2A that is useful for understanding the invention.

FIG. 8 is a perspective view of substrates having cut tie bars that is useful for understanding the invention.

FIG. 9 is a schematic illustration of substrates being removed from a longitudinal deflection test fixture shown in FIG. 2A that is useful for understanding the invention.

FIG. 10 is a side elevation view of a pair of substrates disposed on a carrier substrate which is useful for understanding a ribbon deflection calculation.

### DETAILED DESCRIPTION OF THE PREFERRED EMBODIMENTS

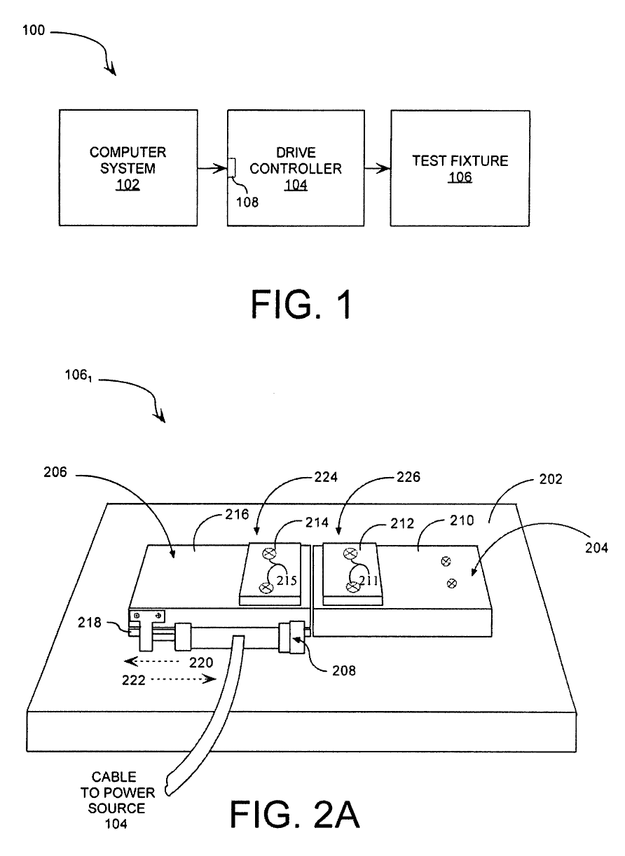

An embodiment of the present invention will now be described with respect to FIG. 1 through FIG. 9. Some embodiments of the present invention provide methods, systems, and apparatus relating to a qualification test for rapidly testing the reliability and quality of sub-miniature interconnects used in manufacturing microelectronic devices. The term “sub-miniature interconnect” as used herein refers to electrical connections formed by fine wires or ribbons formed of a conductive material. The fine wires or ribbons extend between integrated or hybrid circuit chips and the substrate on which they are mounted. The fine wires or ribbons are typically attached to bonding sites formed of conductive pads or circuit traces utilizing a conventional thermo sonic bonding technique. The term “sub-miniature interconnect” also refers to similarly formed electrical connections on a similar scale that are used for any other purpose.

According to the inventive arrangements, an accelerated qualification test can be performed in a three step process. The first step involves determining the number and characteristics of the thermal cycles to which the sub-miniature interconnect is likely to be exposed over some time period. The characteristics of each thermal cycle can include the anticipated temperature variations. The time period can be any time period over which reliability is to be evaluated. For example, the time period can be an anticipated operational lifetime for an item of equipment which is intended to incorporate the sub-miniature interconnect.

A second step can include calculating a thermally induced dimensional variation which is likely to occur for each substrate to which the sub-miniature interconnect is attached. The thermally induced dimensional variation can be used to calculate an anticipated longitudinal and a lateral displacement of a first and second bonding site for a subminiature interconnect which are respectively located on each substrate.

Finally, a sub-miniature interconnect can be assembled for which the reliability is to be evaluated. The sub-miniature interconnect can then be positioned in a test fixture. The test fixture, operating under the control of a computer, causes a displacement of one of the substrates to which the sub-miniature interconnect is connected relative to the other substrate to which the sub-miniature interconnect is connected. The resulting mechanical displacement of the interconnect bonding sites on each substrate is advantageously selected so that it is approximately equivalent to the mechanical displacements caused by a particular thermal variation to which the sub-miniature interconnect will be exposed. This mechanical displacement can be repeated as often as needed to simulate a particular number of thermal cycles.

The resulting qualification process can proceed much more rapidly because the mechanical displacement of the substrates can be performed rapidly, and without the need for extreme variations in temperature. The entire test can be conducted at room temperature, and can easily be monitored. The test can also be performed at temperatures colder or hotter than room temperature by inserting the test fixture into a temperature controlled chamber.

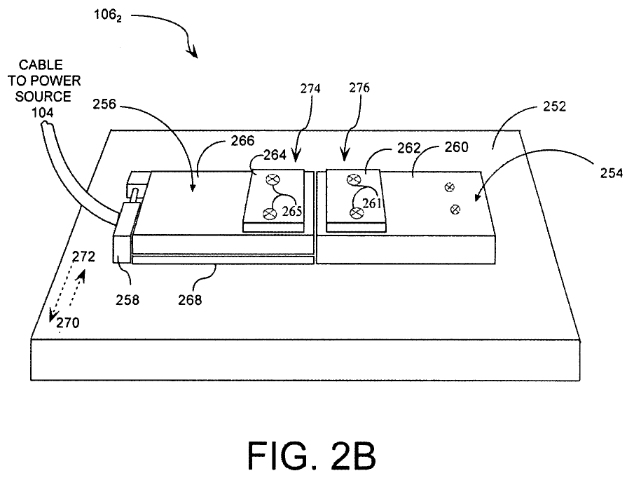

Prior to describing the method in detail, a brief description of the test equipment employed for implementing the qualification test is provided in relation to FIGS. 1, 2A, and 2B. Referring now to FIG. 1, there is provided a block diagram of a tester 100. It should be understood that the tester 100 architecture is one embodiment of a tester architecture. The invention is not limited in this regard. Any tester architecture suitable for implementing the qualification test according to the present invention can be used without limitation.

Referring again to FIG. 1, the tester 100 is comprised of a computer system 102, a drive controller 104, and a test fixture 106. The computer system 102 is a desktop personal computer system, a laptop personal computer system, or any other general purpose computer processing device. The computer system 102 is comprised of hardware and software configured to run a fatigue test software application. The phrase “software application”, in the present context, means any expression, in any language, code, or notation, of a set of instructions intended to cause a system having an information processing capability to perform a particular function either directly or after either or both of the following: a) conversion to another language, code, or notation; or b) reproduction in a different material form.

Referring again to FIG. 1, the fatigue test software application is provided for selectively controlling the drive controller 104 to cause a predetermined amount of mechanical displacement or deflection for simulating a thermal cycle as hereinafter described. The fatigue test software application can also be used to control a number of test cycles for a particular test. In this regard, it should be appreciated that the computer system 102 is electrically connected to an interface 108 of the drive controller 104. The drive controller 104 can be of any type known in the art suitable for controlling the operation of the test fixture as hereinafter described.

The fatigue test software application can also include a suitable user interface to allow a user to input test parameters by communicating with computer system 102. The test parameters can include control parameters for defining a longitudinal or lateral deflection range. The fatigue test software application can also include programming suitable for generating test reports and the like to inform a user of the results of the testing described herein. Still, the invention is not limited in this regard.

Referring again to FIG. 1, the drive controller 104 is comprised of hardware and software configured to supply a signal or control voltage to an actuator (described below in relation to FIGS. 2A and 2B) of the test fixture 106. The precise configuration of the drive controller 104 will depend upon the particular type of actuator which is used in the test fixture 106. The drive controller 104 is advantageously selected so that it is suitable for the particular type of actuator which is used. Drive controllers of this type are well known in the art and therefore will not be described here in detail. The test fixture can be a longitudinal deflection test fixture for simulating longitudinal displacements or a lateral deflection test fixture for simulating lateral displacements. Alternatively, both of these capabilities can be combined into a single test fixture. An illustration of the longitudinal deflection test fixture 106₁ is provided in FIG. 2A. A schematic illustration of a lateral deflection test fixture 106₂ is provided in FIG. 2B.

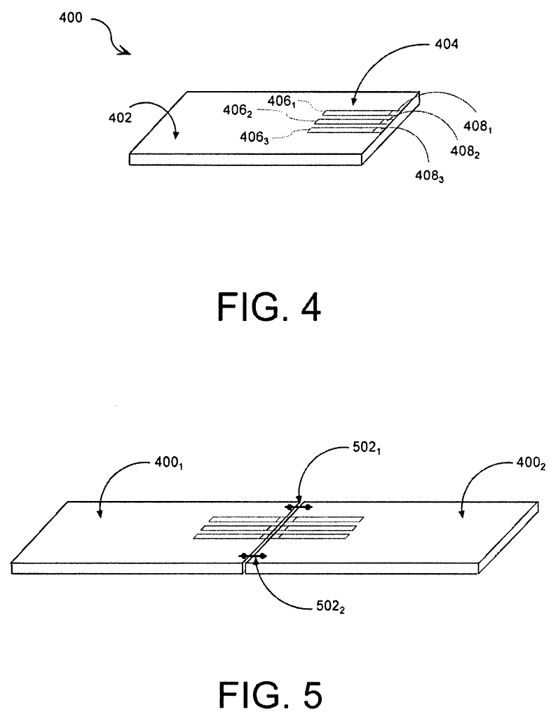

Referring now to FIG. 2A, the longitudinal deflection test fixture 106₁ is comprised of a rigid base 202, a fixed stage structure 204, a cycled stage structure 206, and an actuator 208. The fixed stage structure 204 is comprised of a fixed platen 210 and a clamping member 212. The fixed platen 210 is securely coupled to the rigid base 202. The clamping member 212 is coupled to the fixed platen 210 by means of clamping bolts 211. Clamping bolts 211 allow the clamping member to exert a clamping force against the fixed platen 210. The fixed platen 210, clamping member 212, and the clamping bolts 211 collectively form a fastening device 226. The fastening device 226 is provided for securing a substrate (described below in relation to FIG. 4) to the fixed stage structure 204 through the application of a clamping force.

The cycled stage structure 206 is comprised of a carriage member 218, a movable platen 216, and a clamping member 214. The carriage member 218 is securely coupled to the rigid base 202. The movable platen 216 is slidably mounted on the carriage member 218. According to a preferred embodiment, ball bearings or other suitable friction reducing devices can be provided for reducing friction as between the carriage member 218 and the movable platen 216. The clamping member 214 is coupled to the movable platen 216. Clamping bolts 215 are provided for causing the clamping member 214 to exert a clamping force against the movable platen 216. The clamping member 214, movable platen 216, and the clamping bolts 215 collectively provide a fastening device 224. The fastening device 224 is provided for securing a substrate (described below in relation to FIG. 4) to the cycled stage structure 206 through the application of a clamping force.

The movable platen 216 is securely coupled to the actuator 208. Actuator 208 is configured to slide the movable platen 216 in a first horizontal direction 220 and a second horizontal direction 222 in response to a control signal. This horizontal movement produces longitudinal deflection of the interconnect. The longitudinal direction is a direction that is parallel to an axis connecting two bonding sites on adjacent substrates. In contrast, a lateral direction refers to a direction that is perpendicular to an axis connecting two bonding sites on adjacent substrates. For an example of adjacent substrates, refer to substrates 400₁ and 400₂ in FIG. 5. It should also be appreciated that mechanical deflections caused by thermal variations will generally be on a relatively small scale. For example, the mechanical deflections can typically be less than 10 microns. Accordingly, the actuator 208 must be capable of accurately and repeatedly causing the movable platen 216 to move in a very precise and repeatable way. According to a preferred embodiment, the actuator 208 is preferably capable of repeatedly controlling the motion of movable platen 216 with a precision and accuracy which is better than one (1) microns. Accordingly, actuator 208 can include any actuator arrangement capable of providing this level of performance.

According to a preferred embodiment, the actuator 208 can be a piezoelectric actuator. Piezoelectric actuators are known to produce a very small displacement with a relatively high force capability when a control voltage is applied. Accordingly, they are often used in ultra-precise positioning operations. Piezoelectric actuators feature a response time of 0.01 milliseconds; precision movement of 0.01 microns. Accordingly, such devices are well suited for the application described herein as compared to actuators operated by hydraulic pressure, air pressure, or electromagnetic force. According to one embodiment, the actuator 208 can be a Newport AD-100 available from Newport Corporation of Irvine, Calif. Still, the invention is not limited in this regard.

Referring now to FIG. 2B, the lateral deflection test fixture 106₂ is comprised of a rigid base 252, a fixed stage structure 254, a cycled stage structure 256, and an actuator 258. Each of the listed components 252, 254, 256, 258 of the lateral deflection test fixture 106₂ are similar to the respective components 202, 204, 206, 208 of FIG. 2A. Thus, the description provided above in relation to FIG. 2A is sufficient for understanding the lateral test fixture 106₂ architecture shown in FIG. 2B. However, it should be noted that the fixed stage structure 254 is comprised of a fixed platen 260 and a clamping member 262. The fixed platen 260 is securely coupled to the rigid base 252. The clamping member 262 is coupled to the fixed platen 260 by means of clamping bolts 261. Clamping bolts 261 allow the clamping member to exert a clamping force against the fixed platen 260. The fixed platen 260, clamping member 262, and the clamping bolts 261 collectively form a fastening device 276. The fastening device 276 is provided for securing a substrate (described below) to the fixed stage structure 254 through the application of a clamping force.

The cycled stage structure 256 is comprised of a carriage member 268, a movable platen 256, and a clamping member 264. The carriage member 268 is securely coupled to the rigid base 252. The movable platen 266 is slidably mounted on the carriage member 268. According to a preferred embodiment, ball bearings or other suitable friction reducing devices can be interposed between these structures for reducing friction as between the carriage member 268 and the movable platen 266. The clamping member 264 is coupled to the movable platen 266. Clamping bolts 265 are provided for causing the clamping member 264 to exert a clamping force against the movable platen 266. The clamping member 264, movable platen 266, and the clamping bolts 265 collectively provide a fastening device 274. The fastening device 274 is provided for securing a substrate (described below in relation to FIG. 4) to the cycled stage structure 256 through the application of a clamping force.

The actuator 258 is a mechanical device configured to move the movable platen 266 in a first lateral direction 270 and a second lateral direction 272. The actuator 258 is preferably similar in characteristics and function to the actuator 208 described above in relation to FIG. 2A. According to a preferred embodiment, actuator 258 can also be a piezoelectric actuator.

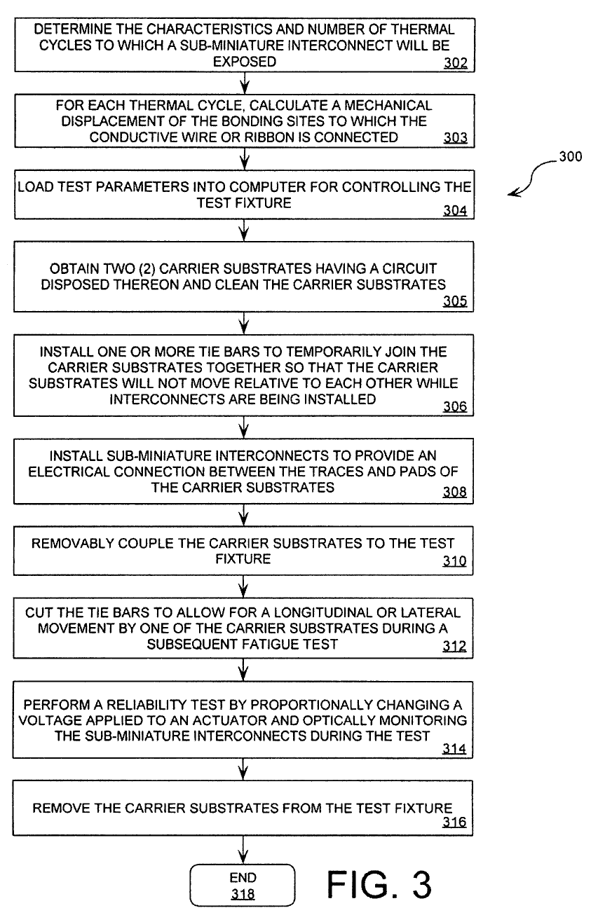

Referring now to FIG. 3, there is provided a flow diagram of a method 300 for testing the reliability of sub-miniature interconnects that is useful for understanding the invention. As shown in FIG. 3, the method 300 begins with step 302. In step 302, a determination is made concerning the thermal variances to which a sub-miniature interconnect will likely be exposed over some period of time. The period of time can be any period of time over which the reliability of the sub-miniature interconnect is to be evaluated. For example, the period of time can include some anticipated operational lifetime for an item of equipment in which the sub-miniature interconnect will likely be used.

The determination of the thermal variances advantageously includes the number and the characteristics of the thermal variances. As used herein, characteristics of thermal variances can include maximum and minimum temperatures that are associated with a particular thermal variance. For example, it can be anticipated that the sub-miniature interconnect will be exposed to several thermal variances having particular characteristics during the manufacturing process. Similarly, it can be anticipated that the sub-miniature interconnect will be exposed to a number of thermal variances having particular characteristics during product testing phase. Finally, it can be determined that the sub-miniature interconnect will be exposed to thousands or even tens of thousands of thermal variances during the period of time when the equipment is in service. Each of these types of thermal variances will have defined maximum and minimum temperature extremes which is determined as part of this step.

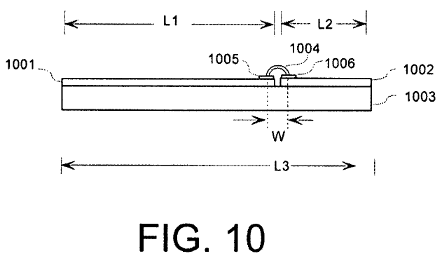

In step 303, a determination is made as to the mechanical displacement of the bonding sites that will result from the thermal variation. This mechanical displacement will generally include a lateral and longitudinal displacement which can be easily calculated by one skilled in the art. For example, the mechanical displacement can be calculated by first determining a longitudinal and lateral dimensional variation of the substrates upon which the bonding sites are disposed, and any relevant dimensional variations in a carrier substrate (see FIG. 10). As used herein, the term longitudinal and lateral dimensional variation refers to a change in any linear dimension of a substrate, such as its length or width. The change in any such linear dimension L arising from a ΔT change in temperature can be calculated by using the following mathematical Equation (1).

ΔL=αLΔT (1)

where
L is the linear dimension;
ΔL is the change in the linear dimension;
α is the coefficient of linear expansion; and
ΔT is the change in temperature.

By using the mathematical Equation (1), the change in the linear dimensions of adjacent substrates can be easily calculated if the temperature variance ΔT is known. By using the calculated variation in linear dimensions of the adjacent substrates, one can also calculate a maximum mechanical displacement or variation in the relative position of a first bonding site on a first one of the adjacent substrates and a second bonding site on a second one of the adjacent substrates. Once the lateral and longitudinal dimensional variations have been calculated for each known temperature variance, these values can be provided to computer system 102 as test parameters in step 304. It will be appreciated by those skilled in the art that computer system 102 can also be programmed to automatically convert temperature variations to dimensional variations. A computer system 102 can also be used to calculate a maximum variation in the relative position of the first bonding site relative to a second bonding site. A more detailed explanation of the manner in which these calculations are performed is described below in relation to FIG. 10. In step 304, it is preferred that the computer system 102 also be provided with additional test parameters, such as the number of times each temperature variation will occur (as determined in step 302). However, the invention is not limited in this regard.

It should be understood from the foregoing that the displacement of a first bonding site relative to a second bonding site can be determined by calculation if the temperature variation and other material variables are known. However, it will be appreciated by those skilled in the art that the invention is not limited in this regard. For example, in an alternative embodiment of the invention, the determination of such displacement of bonding sites for a given temperature variation can also be measured empirically. In other words, the actual displacement of the bonding sites can be measured for a given temperature variation. However, this approach is believed to be less convenient as compared to simply calculating such displacement.

Referring again to FIG. 3, steps 305, 306 and 308 generally relate to the assembly of a set of sub-miniature interconnects for which reliability testing is to be performed. Accordingly, the substrate materials, bonding sites on the substrate materials, wire bonding techniques, and connecting wires or ribbons are preferably selected so they are consistent with the characteristics of a sub-miniature interconnect for which reliability testing is to be performed. For example, the characteristics can be selected so that they are consistent with a sub-miniature interconnect under consideration for use in a particular item of equipment.

In step 305, two (2) substrates are obtained. Step 305 can also involve cleaning the substrates utilizing any cleaning technique known in the art. Such cleaning techniques include, but are not limited to, a plasma cleaning technique configured for removing impurities and contaminants from surfaces of substrates. A perspective view of a substrate is provided in FIG. 4 that is useful for understanding the invention.

Referring now to FIG. 4, each substrate 400 can be comprised of a board 402 having a circuit 404. The circuit 404 can be comprised of one or more conductive traces 406₁, 406₂, 406₃ and one or more conductive pads 408₁, 408₂, 408₃. The traces 406₁, 406₂, 406₃ and conductive pads 408₁, 408₂, 408₃ can be made of a conductive material, such as copper, nickel, kovar, or steel. Each trace 406₁, 406₂, 406₃ can terminate at the connector portion in the form of a pad 408₁, 408₂, 408₃, respectively. The pads 408₁, 408₂, 408₃ can provide a bonding site for bonding a wire or ribbon to form an electrical connection between the circuit 404 of a first substrate and a circuit 404 of a second substrate (not shown). The traces 406₁, 406₂, 406₃ and pads 408₁, 408₂, 408₃ can be formed by any method commonly used in the art, such as a physical etching method or a sputter etching method.

Referring again to FIG. 3, the method 300 continues with a step 306. In step 306, the substrates are joined together using one or more tie bars. In this regard, it should be noted that the tie bars are employed for ensuring that the substrates will not move relative to each other while interconnects are being installed in a subsequent step. A perspective view of a first substrate coupled to a second substrate is provided in FIG. 5.

Referring now to FIG. 5, a first substrate 400₁ is mechanically coupled to a second substrate 400₂ via two (2) tie bars 502₁, 502₂. The tie bars 502₁, 502₂ can be formed of steel, Kovar, an alloy, or any other suitable rigid material. According to one embodiment, the tie bars 502₁, 502₂ can be secured to the first and second substrates 400₁, 400₂ via an adhesive. Such adhesives include, but are not limited to, an epoxy or cyanoacrylate adhesive. Still, the invention is not limited in this regard.

Referring again to FIG. 3, the method 300 continues with a step 308. In step 308, one or more conductive metal wires or ribbons are installed for providing an electrical connection between the pads 408₁, 408₂, 408₃ of the substrates 400₁, 400₂. The installation can involve bonding the conductive metal wires or ribbons to pads (bonding sites) of the substrates 400₁, 400₂ to complete the sub-miniature interconnect. The bonding can be accomplished using any suitable bonding technique known in the art. Such techniques include, but are not limited to, thermo sonic and ultrasonic bonding techniques, a parallel gap welding technique, and a soldering technique. The interconnect installation can also involve measuring bond deformations on the interconnects 602₁, 602₂, 603₃ utilizing any bond measurement method known in the art. The interconnect installation can further involve performing a bonding inspection. Bonding inspections are well known to persons skilled in the art, and therefore will not be described in great detail herein.

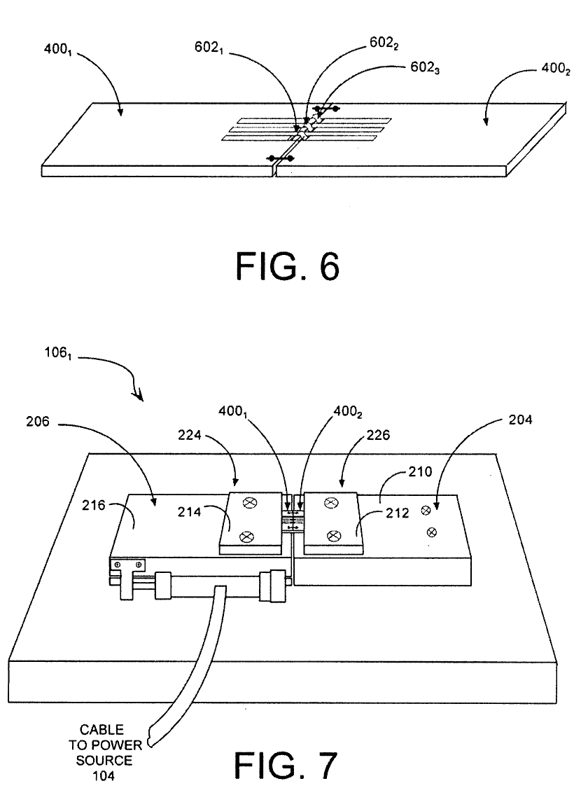

A perspective view of the substrates 400₁, 400₂ having sub-miniature interconnects is provided in FIG. 6. The wires or ribbons 602₁, 602₂, 602₃ are formed from any electrically conductive material. Such electrically conductive materials include, but are not limited to, copper, aluminum, gold, silver, and alloys thereof.

Referring again to FIG. 3, the method 300 continues with step 310. In step 310, the substrates 400₁, 400₂ are positioned in a longitudinal deflection test fixture 106₁ (described above in relation to FIG. 2A) or a lateral deflection test fixture 106₂ (described above in relation to FIG. 2B). A perspective view of the substrates 400₁, 400₂ removably positioned in a longitudinal deflection test fixture 106₁ is provided in FIG. 7. According to a preferred embodiment, the substrates 400₁, 400₂ can be secured using the fastening devices 224 and 226. More particularly, the substrate 400₁ is clamped between the clamping member 214 (described above in relation to FIG. 2A) and the movable platen 216 (described above in relation to FIG. 2A). Similarly, the substrate 400₂ is clamped between the fixed platen 210 (described above in relation to FIG. 2A) and a clamping member 212 (described above in relation to FIG. 2A).

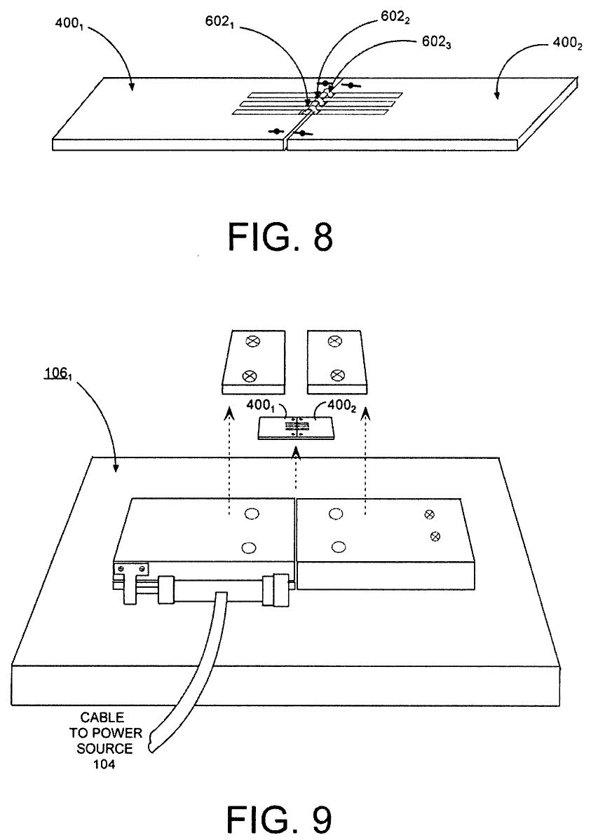

Referring again to FIG. 3, the method 300 continues with a step 312. Step 312 involves cutting the tie bars 502₁, 502₂ (described above in relation to FIG. 5). Step 312 is performed to allow longitudinal or lateral movement of the substrate 400₁ relative to the substrate 400₂ during a subsequent fatigue test. A perspective view of the substrates 400₁, 400₂ having cut tie bars 502₁, 502₂ is provided in FIG. 8. For greater clarity in FIG. 8, the test fixture 106 is not shown.

After step 312, the method 300 continues with a step 314 where a fatigue test is performed to test the reliability of the sub-miniature interconnects 602₁, 602₂, 602₃ (described above in relation to FIG. 6). Advantageously, step 314 can be performed at room temperature. Step 314 can also advantageously involve monitoring the sub-miniature interconnects 602₁, 602₂, 602₃ during the fatigue test. This monitoring can be accomplished utilizing a microscope. By comparison, it should be noted that it can be highly impractical to monitor the sub-miniature interconnects 602₁, 602₂, 602₃ in this way in the case of a conventional fatigue tests utilizing a thermal chamber to implement an accelerated temperature cycling process.

The fatigue test in step 314 can include several steps. For example, the step can include adjusting the test fixture 106₁ or 106₂ to set an initial condition position for substrates 400₁, 400₂. For example, the initial position condition can be chosen so that the span of the conductive ribbon or wire forming the sub-miniature interconnect is equal to that which would be expected at the minimum temperature associated with a particular temperature variance. As used herein, the term “span” refers to the distance between the bonding sites which exist at opposing ends of the ribbon wire forming the sub-miniature interconnect.

More particularly, the movable platen 216 or 266 is moved in a very precise way relative to its respective fixed platen 210, 260. The movable platen 216, 266 is positioned in this way to create an initial position condition for substrates 400₁, 400₂ which results in a ribbon span that is equivalent to that which would be expected at a minimum temperature associated with a particular known temperature variance. This position can be determined by using the mathematical Equation (1) as described above. Those skilled in the art will appreciate that the initial condition is not necessarily limited to the position of the substrates 400₁, 400₂ which would exist at the minimum temperature associated with a particular known temperature variance. Any other initial position of the substrates could also be chosen. For example, the initial condition could be set such that the initial position condition of substrates 400₁, 400₂ is equivalent to that which would be expected at a maximum temperature associated with a particular known temperature variance.

Once the movable platen 216 has been set to its initial position condition the remainder of the fatigue test can commence. Using the test parameters provided in step 304, the computer 102 (controlled by a fatigue test software application) can communicate signals to the drive controller 104. These signals can cause the drive controller to selectively move the actuator 208, 258. The drive controller 104 communicates necessary signals to the actuator 208, 258 for producing the movements to the movable platen and substrates 400₁, 400₂ mounted thereon as specified by the test parameters.

For example, consider the case where a particular thermal cycle is known to cause a longitudinal or lateral displacement of the bonding sites equal to one (1) mil. Given these test parameters, the computer system 102 will cause the actuator 208, 258 to move the movable platen 216, 266 an equivalent distance (1 mil) responsive to control signals from the drive controller 104. Tension springs in the carriage member 218 (FIG. 2A) will cause the movable platen 216, 266 to return to its initial position condition. The displacement of the substrates in this way simulates one (1) test cycle.

The fatigue test software application is advantageously programmed to cause the computer system 102 to repeat the test cycle simulation in accordance with the test parameters determined in step 302. For example, a particular thermal cycle may occur ten (10) times as part of an anticipated manufacturing process which includes the sub-miniature interconnect. In that case, the test cycle described above can be repeated ten (10) times to simulate the fatigue caused to the sub-miniature interconnect during the manufacturing process.

FIG. 10 is useful for understanding how a positional variation can be calculated as between a first conductive pad 1005 and a second conductive pad 1006. The first and second conductive pads respectively comprise a ribbon terminal or bonding site disposed on the first substrate 1001 and the second substrate 1002. As shown in FIG. 10, the first substrate 1001, and the second substrate 1002 are disposed on a carrier substrate 1003. An interconnect comprising a conductive metal ribbon 104 extends between the first conductive pad 1005 and the second conductive pad 1006. In the following example associated with FIG. 10:

L1 is the length of first substrate 1001
L2 is the length of second substrate 1002
L3 is the length of carrier substrate 1003
W is the distance between the first and second conductive pads 1005, 1006
α₁₀₀₁ is the coefficient of linear expansion for first substrate 1001
α₁₀₀₂ is the coefficient of linear expansion for second substrate 1002
α₁₀₀₃ is the coefficient of linear expansion for carrier substrate 1003
ΔWₘₐₓ is the change in W for the maximum anticipated temperature variation ΔT.

### EXAMPLE

L1/2=1.08 inches

L2/2=0.32 inches

L3=1.08 inches+0.32 inches=1.40 inches

α₁₀₀₁=6.8×10⁻⁶ ppm/C

α₁₀₀₂=7.0×10⁻⁶ ppm/C

α₁₀₀₃=13.9×10⁻⁶ ppm/C

Given the foregoing, a maximum variation ΔWₘₐₓ can be calculated as follows:

ΔWₘₐₓ=(α₁₀₀₃*L3*ΔT)−(α₁₀₀₁*L1/2*ΔT)−(α₁₀₀₂*L2/2*ΔT)

### For a ΔT=100° C.

ΔWₘₐₓ=(13.9×10⁻⁶*1.40*100)−(6.8×10⁻⁶*1.08*100)−(7.0×10⁻⁶*0.32*100)

ΔWₘₐₓ=0.00099 inches

Those skilled in the art will readily appreciate that the foregoing process can be repeated for other thermal variations that may be experienced by the sub-miniature interconnect. For example, in step 302 it may be determined that during the operational lifetime of an item of equipment, the sub-miniature interconnect will be subjected to approximately eighty thousand (80,000) thermal cycles. Further, it can be determined that each thermal cycle will cause a longitudinal or lateral displacement of the ribbon or wire bonding sites of the sub-miniature interconnect equal to three tenths of a mil (0.3 mil). In that case, the substrates 400₁, 400₂ can be set to an initial position condition, and the three tenths of a mil (0.3 mil) longitudinal or lateral displacement can be repeated eighty thousand (80,000) times by using the actuator 208, 258. The testing can continue in this way for each type of thermal variation that the sub-miniature interconnect is expected to experience over some period of time, such as its operational life.

Referring again to FIG. 3, the method 300 continues with a step 316. In step 316, the substrates are removed from the test fixture 106₁, 106₂. A schematic illustration of the substrates 400₁, 400₂ being removed from the test fixture 106₁ is provided in FIG. 9. Thereafter, step 318 is performed where the method 300 ends.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

1. A method for performing an accelerated simulation of mechanical stresses and strains to evaluate the reliability of a sub-miniature interconnect, comprising:
determining at least one characteristic of at least one thermal cycle to which a sub-miniature interconnect having a predetermined configuration will be exposed;
calculating at least one value representing a dimensional variation in a substrate to which the sub-miniature interconnect is bonded, the dimensional variation resulting from the at least one thermal cycle; and
testing a response of the sub-miniature interconnect to the at least one thermal cycle by selectively varying a position of at least one bonding site where a ribbon or a wire forming the sub-miniature interconnect is bonded to a substrate, and wherein the selectively varying step is performed exclusive of varying a temperature of the substrate.

2. The method according to claim 1, further comprising determining a first value representing a number of times it is anticipated that the sub-miniature interconnect having the predetermined configuration will be exposed to the at least one thermal cycle.

3. The method according to claim 2, further comprising repeating the testing step a predetermined number of times based on the first value.

4. The method according to claim 1, further comprising varying the position of the at least one bonding site by using an actuator responsive to a computer control.

5. The method according to claim 4, further comprising selecting the actuator to be a piezoelectric actuator.

6. The method according to claim 1, further comprising selecting the dimensional variation to include a longitudinal dimensional variation aligned with a length of the ribbon or the wire.

7. The method according to claim 1, further comprising selecting the dimensional variation to include a lateral dimensional variation aligned transverse to a length of the ribbon or the wire.

8. The method according to claim 1, further comprising assembling a sample of the sub-miniature interconnect having the predetermined configuration, the sample sub-miniature interconnect formed by:
temporarily securing a first substrate to a second substrate;
bonding a conductive wire or ribbon to the first substrate at one end and to the second substrate at an opposing end; and
unsecuring the first substrate from the second substrate after positioning the first substrate and the second substrate in a test fixture.

9. The method according to claim 8, further comprising moving the first substrate relative to a position of the second substrate to simulate a dimensional variation caused by the at least one thermal cycle.

10. The method according to claim 9, further comprising selecting the moving step to include moving the first substrate laterally relative to the second substrate to simulate the dimensional variation caused by the at least one thermal cycle.

11. The method according to claim 9, further comprising selecting the moving step to include moving the first substrate longitudinally relative to the second substrate to simulate the dimensional variation caused by the at least one thermal cycle.

12. The method according to claim 1, further comprising selecting the at least one characteristic to include a temperature change during the at least one thermal cycle.

13.-19. (canceled)

20. An accelerated test method for sub-miniature interconnects, comprising:
determining a temperature variation to which a sub-miniature interconnect will be exposed;
calculating a change in position that will occur as a result of the temperature variation as between a first bonding site to which the sub-miniature interconnect is connected on a first substrate, and a second bonding site to which the sub-miniature interconnect is connected on a second substrate; and
simulating a mechanical response of the sub-miniature interconnect to the temperature variation by using an actuator to selectively vary a relative position of the first substrate with respect to the second substrate in accordance with the calculated change in position.

21. The method according to claim 20, further comprising performing the simulating step exclusive of any delay associated with establishing the temperature variation.

22. The method according to claim 20, further comprising selecting the temperature variation to correspond to a predetermined thermal cycle over which a reliability of the sub-miniature interconnect is to be evaluated.

23. The method according to claim 22, further comprising repeating the simulating step a predetermined number of times corresponding to a number of the predetermined thermal cycles over which the reliability is to be evaluated.

24. The method according to claim 23, further comprising repeating the simulating step the predetermined number of times exclusive of any delay associated with establishing the temperature variation.

25. The method according to claim 20, wherein the calculating step comprises calculating a change in a lateral position of the first bonding site relative to the second bonding site, wherein the change in lateral position is a positional change in a lateral direction defined transverse to an axis aligned with the first bonding site and the second bonding site.

26. The method according to claim 20, wherein the calculating step comprises calculating a change in a longitudinal position of the first bonding site relative to the second bonding site, wherein the change in lateral position is a positional change in a longitudinal direction defined by an axis aligned with the first bonding site and the second bonding site.

27. The method according to claim 20, wherein the simulating step further comprises using the actuator to selectively vary a relative position of the first substrate with respect to the second substrate in a lateral direction in accordance with a calculated lateral change in position, the lateral direction defined transverse to an axis aligned with the first bonding site and the second bonding site.

28. The method according to claim 20, wherein the simulating step further comprises using the actuator to selectively vary a relative position of the first substrate with respect to the second substrate in a longitudinal direction in accordance with a calculated longitudinal change in position, the longitudinal direction defined by an axis aligned with the first bonding site and the second bonding site.

29. The method according to claim 20, further comprising selecting the actuator to include a piezoelectric actuator.

30. An accelerated test method for sub-miniature interconnects, comprising:
determining a temperature variation to which a sub-miniature interconnect will be exposed, the temperature variation corresponding to a predetermined thermal cycle over which a reliability of the sub-miniature interconnect is to be evaluated;
calculating a change in position that will occur as a result of the temperature variation as between a first bonding site to which the sub-miniature interconnect is connected on a first substrate, and a second bonding site to which the sub-miniature interconnect is connected on a second substrate;
simulating a mechanical response of the sub-miniature interconnect to the temperature variation by using an actuator to selectively vary a relative position of the first substrate with respect to the second substrate in accordance with the calculated change in position;
repeating the simulating step a predetermined number of times corresponding to a number of the predetermined thermal cycles over which the reliability is to be evaluated.

31. The method according to claim 30, further comprising repeating the simulating step the predetermined number of times exclusive of any delay associated with establishing the temperature variation.

32. An accelerated test method for sub-miniature interconnects, comprising:
determining a temperature variation to which a sub-miniature interconnect will be exposed, the temperature variation corresponding to a predetermined thermal cycle over which a reliability of the sub-miniature interconnect is to be evaluated;
determining a change in position that will occur as a result of the temperature variation as between a first bonding site to which the sub-miniature interconnect is connected on a first substrate, and a second bonding site to which the sub-miniature interconnect is connected on a second substrate;
simulating a mechanical response of the sub-miniature interconnect to the temperature variation by using an actuator to selectively vary a relative position of the first substrate with respect to the second substrate in accordance with the change in position;
repeating the simulating step a predetermined number of times corresponding to a number of the predetermined thermal cycles over which the reliability is to be evaluated.
